(19) United States
(12) Patent Application Publication
(10) Pub. No.: US 2021/0402706 A1
(43) Pub. Date: Dec. 30, 2021

(54) MATERIAL LEVEL ESTIMATIONS BASED ON OSCILLATION FREQUENCIES

(71) Applicant: HEWLETT-PACKARD DEVELOPMENT COMPANY, L.P., Spring, TX (US)

(72) Inventors: David Soriano Fosas, Vancouver, WA (US); Sergio De Santiago Dominguez, Sant Cugat del Valles (ES); Mayid Shawi Sanchez, Sant Cugat del Valles (ES)

(21) Appl. No.: 16/607,793

(22) PCT Filed: Apr. 27, 2018
(86) PCT No.: PCT/US2018/029757

§ 371 Date: Oct. 24, 2019

(51) Int. Cl. B29C 64/393; B29C 64/314; B29C 64/321; B33Y 30/00; B33Y 40/10; B33Y 50/02

(52) U.S. Cl. CPC B29C 64/393; B29C 64/314; B29C 64/321; B29C 64/153; B33Y 40/10; B33Y 50/02; B33Y 30/00

(57) ABSTRACT

In some examples, a controller is to receive a measurement of an electrical property of an oscillation control system from a sensor, determine, based on the measurement of the electrical property, a frequency of oscillation of a structure vibrated by the oscillation control system in the system, the vibration of the structure to cause passage of a portion of a material through the structure, and estimate a level of a remaining portion of the material at the structure based on the determined frequency of oscillation of the structure.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a block diagram of an example system that includes a sieve that can be vibrated, and a material level estimation engine for estimating a level of a material at the sieve, in accordance with some implementations of the present disclosure.

FIG. 2 is a graph illustrating impedance as a function of frequency, useable for estimating a level of a material in a sieve, according to some examples.

FIG. 3 is a block diagram of an apparatus for a system, in accordance with further examples.

FIG. 4 is a block diagram of a printing system according to additional examples.

FIG. 5 is a block diagram of a storage medium storing machine-readable instructions according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In a 3D printing system, a build material can be used to form a 3D object, by depositing the build material as successive layers until the final 3D object is formed. In some examples, a build material can include a powdered build material that is composed of particles in the form of fine powder or granules. The powdered build material can include metal particles, plastic particles, polymer particles, ceramic particles, or particles of other powder-like materials. In some examples, a build material powder may be formed from, or may include, short fibers that may, for example, have been cut into short lengths from long strands or threads of material.

The 3D object can be formed on a build platform of the 3D printing system. Any incidental build material that is not used in forming the 3D object can be passed back to a build material reservoir. To filter out an agglomerated clump of the build material or other objects, the incidental build material can be passed through a sieve to the build material reservoir. The sieve has small openings to allow the particles of the incidental build material to pass through, while blocking larger objects. In some examples, a sieve can be implemented as a mesh frame with the small openings. In other examples, a sieve can have other implementations.

In some examples, an optical sensor can be used to detect a level of build material at the sieve. If the sieve becomes clogged, then build material can accumulate at the sieve. If the optical sensor detects a level of build material at the sieve that exceeds a threshold level, then that provides an indication of clogging of the sieve such that servicing of the sieve should be performed. However, some issues with optical sensors are that they can be costly and have to be frequently cleaned (especially in environments with small particles of build material) to ensure proper optical-based detection of build material levels at the sieve.

In other examples, a capacitive level sensor can be used to detect a level of build material at the sieve. However, capacitive level sensors can also be costly and may be damaged by vibration of the sieve.

In accordance with some implementations of the present disclosure, a simple sensing mechanism can be used to determine a level of a material (e.g., a build material in powder form) at a structure (e.g., a sieve). A “level” of a material at a structure can refer to any indication of an amount of the material contained in the structure or provided onto the structure. The sensing mechanism includes a controller to receive a measurement of an electrical property of an oscillation control system from a sensor, determine a frequency of oscillation of a structure vibrated by the oscillation control system, and estimate a level of a material at the structure based on the determined frequency of oscillation of the structure.

In the ensuing discussion, although reference is made to estimating levels of materials in 3D printing systems, it is noted that techniques or mechanisms according to some implementations of the present disclosure can be used to estimate levels of materials in other types of systems.

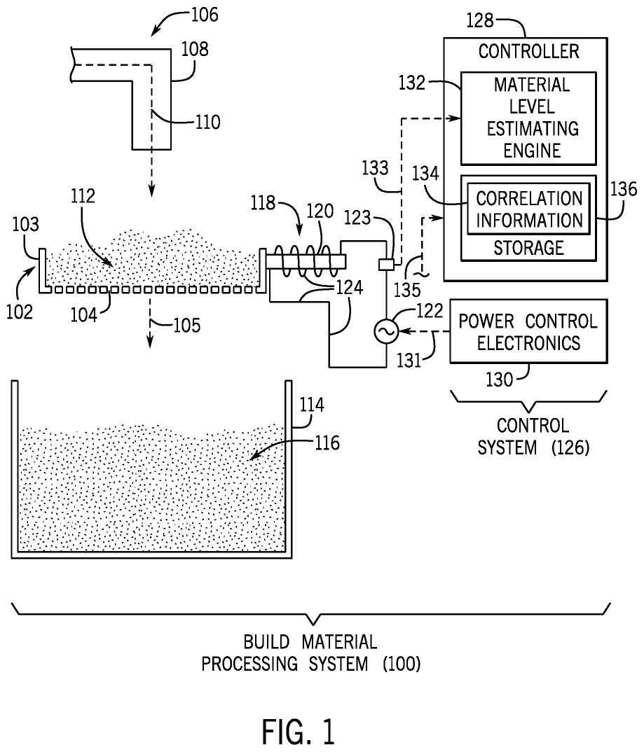

FIG. 1 is a block diagram of a build material processing system 100 that can be used in a 3D printing system, according to some examples. The build material processing system 100 may be integrated into a 3D printing system, or alternatively, the build material processing system 100 may be part of a separate 3D printing build material management system (separate from a 3D printing system).

The build material processing system 100 includes a sieve 102. In the example shown, the sieve 102 is generally an open-topped container 103 that has a base at least partially formed of a sieve element 104. In other examples, the sieve 102 may be partially closed at the top.

The sieve element 104 includes small openings through which a build material having less than a specified size can pass. Effectively, the sieve element 104 filters the build material, such that build material particles or other particles larger than a specified size (or sizes) cannot pass. For example, the sieve element 104 may be in the form of a mesh, a screen, an apertured plate, and so forth. The sieve element 104 can include apertures of a single size, or apertures of a range of different sizes. The size, or sizes, of the apertures of the sieve element 104 may be chosen based on characteristics of the build material that is to be processed by the build material processing system 100.

For example, the size of the apertures may be chosen to allow only build material particles having a predetermined maximum particle size to pass through the sieve element 104. In this way, any agglomerated build materials or any other contaminants having a size larger than the apertures can be either broken down by the sieve element 104 such that the broken down materials pass through the sieve element 104, or the larger materials are stopped from passing through the sieve element 104.

The build material can be delivered to the sieve 102 using a build material transport system 106. The build material transport system 106 can include a tube or other conduit 108 through which the build material can flow to the sieve 102. In other examples, the build material transport system 106 can include a hopper to direct the build material to the sieve 102. Build material flows through the build material transport system 106 into the sieve 102 along a path generally indicated by arrow 110.

The flow of build material through the build material transport system 106 can be controlled by a flow regulator (not shown). The flow regulator can include a valve that has an open position and a closed position. In further examples the valve allows a restricted flow between the open and closed position.

As shown in FIG. 1, a portion of the build material 112 has not yet passed through the sieve element 104. Build material that has passed through the sieve element 104 falls (generally along direction 105) into a build material reservoir 114, which includes a container to receive the build material 116 that has been sieved (i.e., passed through the sieve element 104).

The build material that has been sieved is considered to be clean build material that can be used in a subsequent 3D printing process.

The build material processing system 100 further includes a vibrator mechanism 118 that is attached to the sieve 102. For example, the vibrator mechanism 118 can be mounted to a side housing of the sieve 102, or can be otherwise attached by a rigid attachment mechanism to any other part of the sieve 102.

The vibrator mechanism 118 is to impart small amplitude vibrations to the sieve 102 along one axis or along multiple different axes. The vibrations assist build material in the sieve 102 in passing through the sieve element 104 as indicated by 105. In some examples, the sieve 102 can be mounted on springs (not shown) that allow the sieve 102 to vibrate without transferring the vibrations to other parts of the build material processing system 100.

In some examples, the vibration mechanism 118 includes an electromagnet actuator 120 that produces a magnetic field in response to an applied voltage. As depicted in FIG. 1, an alternating current (AC) voltage source 122 can provide an AC voltage to the electromagnet actuator 120 through an electrical wire 124. The electrical wire 124 can include an electrical conductor (or multiple electrical conductors). The AC voltage can be in the form of a sinusoidal waveform, which oscillates at a specific frequency. In other examples, other types of voltage waveforms can be used.

Magnetic fields produced by activation of the electromagnet actuator 120 causes a vibrating motor or solenoid (which is part of the vibration mechanism 118) to vibrate the sieve 102. The AC voltage from the AC voltage source 122 causes fluctuations in the magnetic field produced by the electromagnet actuator 120 such that vibration is produced by the vibration mechanism 118.

The build material processing system 100 further includes a control system 126 that is used to control the vibration mechanism 118. The control system 126 includes a controller 128 and power control electronics 130. The controller 128 can be implemented using any or some combination of a microprocessor, a core of a multi-core microprocessor, a microcontroller, a programmable integrated circuit device, a programmable gate array, or any other hardware processing circuit. Alternatively, the controller 128 can be implemented as a combination of a hardware processing circuit and machine-readable instructions (software and/or firmware) executable on the hardware processing circuit.

The power control electronics 130 supplies a voltage control signal 131 to the AC voltage source 122, to activate or deactivate the AC power source 122. The power control electronics 130 can also control the frequency of oscillation of the AC voltage produced by the AC voltage source 122.

Examples of components in the power control electronics 130 include amplifiers, oscillators, and so forth. Although the power control electronics 130 is shown as being separate from the controller 128, it is noted that in other examples, the power control electronics 130 can be part of the controller 128.

In examples where the build material processing system 100 is integrated into a 3D printing system, the controller 128 can be the printing system controller that is used to control 3D printing operations.

In accordance with some implementations of the present disclosure, an electrical sensor 123 is used to sense an electrical property of the vibration mechanism 118. The sensor 123 outputs measurement information 133 to the controller 128.

Collectively, the vibration mechanism 118 and the control system 126 can be considered to be example components of an oscillation control system that controls the vibration of the sieve 102. The sensor 123 is thus a sensor to measure an electrical property of the oscillation control system.

In some examples, the sensor 123 is an electrical current sensor to sense current passing through the electrical wire 124 that drives the AC voltage to the electromagnet actuator 120. The measured electrical current from the sensor 123 can be provided as an input (133) to the controller 128.

Voltage information 135 pertaining to the AC voltage produced by the AC voltage source 122 can also be provided to the controller 128, such as in feedback information from the power control electronics 130 to the controller 128.

In other examples, a voltage sensor can be used to measure the AC voltage output by the AC voltage source 122, and the measured voltage can be provided as an input (135) to the controller 128.

Using a measured electrical property (or multiple electrical properties), such as information 133 and 135, a material level estimation engine 132 in the controller 128 is able to determine a frequency of oscillation of the sieve 102 as vibrated by the oscillation control system. Based on the determined frequency of oscillation of the sieve 102 (or more specifically, the resonant frequency of the sieve 102 as explained further below), the material level estimation engine 132 in the controller 128 is able to estimate a level of the build material 112 that is in the sieve 102.

The material level estimation engine 132 can be implemented as a portion of the hardware processing circuit of the controller 128. Alternatively, the material level estimation engine 132 can be implemented as machine-readable instructions executable on the hardware processing circuit of the controller 128.

The resonant frequency of the sieve 102 changes with a change in quantity of the build material 112 in the sieve 102. The change in the quantity of the build material 112 in the sieve 102 changes the overall mass of the sieve 102; i.e., as more build material 112 is added to the sieve 102, the overall mass of the sieve 102 increases. The change in mass causes a change in the resonant frequency of the sieve 102.

By using a simple electrical sensor 123 such as a current sensor and/or a voltage sensor, more complex sensors, such as optical sensors, accelerometers, and so forth, would not be employed for detecting the amount of build material in the sieve 102. As noted above, optical sensors can be blocked by powder that may cover lenses or other optical elements of optical sensors. Optical sensors can also be costly, as are other types of sensors such as accelerometers.

In some examples, the material level estimation engine 132 can compute an impedance, Z(f), based on a measured electrical current, I(t), such as measured by the sensor 123, and an applied voltage V(t), as applied by the voltage source 122, according to Eq. 1 below:

$$Z ( f ) = \frac{V ( t )}{I ( t )} . \qquad ( Eq . 1 )$$

In Eq. 1, t represents time. Note that since the applied voltage is an AC voltage, the voltage, V(t), varies as a function of time. The current, I(t), similarly varies as a function of time.

The controller 128 can cause the power control electronics 130 to sweep through a range of frequencies of the AC voltage applied by the AC voltage source 122. Sweeping through this range of frequencies allows for the resonant frequency of the combination of the sieve 102 and build material 112 to be determined.

Once the resonant frequency of the combination of the sieve 102 and build material 112 is computed, the material level estimation engine 132 can use the computed resonant frequency to estimate the level of the build material 112 in the sieve 102.

In some examples, the material level estimation engine 132 can access a correlation information 134 (e.g., a correlation table) stored in a storage 136, which can be implemented using a memory device and/or another type of storage device (or multiple memory devices and/or other types of storage devices). The correlation information 134 can be empirically determined to correlate different resonant frequencies to corresponding levels of build material in the sieve 102.

For different types of build material processing systems 100 (or different types of 3D printing systems), different correlation information 134 can be provided.

The correlation information 134 can include multiple entries, where each entry maps a frequency (e.g., resonant frequency) of the sieve 102 to a corresponding level of a build material. Thus, the multiple entries of the map respective different frequencies to corresponding different levels of the build material.

In other examples, instead of using the correlation information 134, the material level estimation engine 132 can instead apply a formula, curve, polynomial approximation, model, or any other representation, that computes a level of build material given an input frequency of the sieve 102. The formula or model relates different frequencies of oscillation to different levels of the build material at the sieve 102.

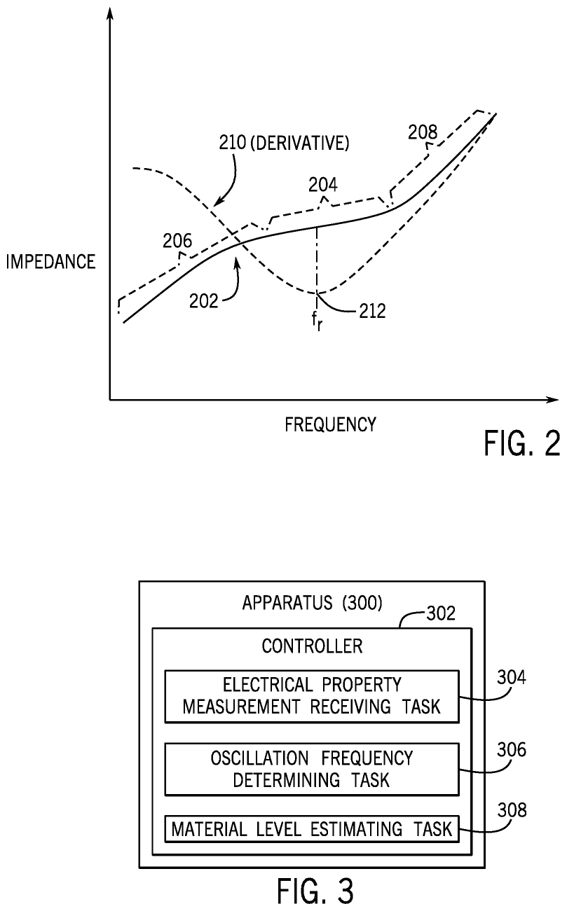

FIG. 2 is a graph that illustrates a curve 202 that represents the absolute value of the real portion of the impedance, Z(f) (vertical axis), |Z(f)|, where Z(f) is calculated by Eq. 1, as a function of frequency, f (horizontal axis).

Generally, the impedance, Z(f), increases with increasing frequency. However, this increase is not monotonic, since there is a region 204 of the curve 202 where a slope of the increase in impedance as a function of frequency is less than other regions 206 and 208 of the curve 202. The resonant frequency fᵣ of the combination of the sieve 102 and the build material 112 occurs somewhere within this range 204 (referred to as a notch or discontinuity in the curve 202).

To identify this notch region 204, the derivative of the impedance absolute value, |Z(f)|, with respect to frequency,

$$\frac{d \vert Z ( f ) \vert}{df} ,$$

is computed. FIG. 2 shows a curve 210 that represents

$$\frac{d \vert Z ( f ) \vert}{df} .$$

A minimum value (212) of the derivative,

$$\frac{d Z ( f )}{df} ,$$

occurs within a range of frequencies defined by the notch region 204. Thus, in some examples, the frequency at which the minimum value (212) of the derivative,

$$\frac{d Z ( f )}{df} ,$$

occurs is considered to be the resonant frequency, fᵣ.

The sieve 102 behaves as a mass-stiffness-damping oscillator system, such that its resonant frequency can be expressed as

$${f}_{r} = \frac{1}{2 π} \sqrt{\frac{k}{{M}_{s} + {M}_{b}}} , \qquad ( Eq . 2 )$$

where Mₛ represents the mass of the sieve 102 and M_{b} represents the mass of the build material 112 in the sieve 102. Since the mass of the sieve 102 is known, once the resonant frequency fᵣ is determined by the material level estimation engine 132, the material level estimation engine 132 can in turn estimate the amount of build material in the sieve 102 (based on accessing the correlation data structure 134 or applying a formula or model), and thus, a level of the build material in the sieve 102.

FIG. 3 is a block diagram of an apparatus 300 according to some examples. The apparatus 300 includes a controller 302 to perform various tasks. The controller 302 can be similar to the controller 128 of FIG. 1, for example. The tasks of the controller 302 can be performed by a hardware processing circuit of the controller 302 or by machine-readable instructions executable on the controller 302. For example, the tasks of the controller 302 can be performed by the material level estimating engine 132 of FIG. 1.

The tasks of the controller 302 include an electrical property measurement receiving task 304 to receive a measurement of an electrical property of an oscillation control system from a sensor (e.g., 123 in FIG. 1). The tasks further include an oscillation frequency determining task 306 to determine, based on the measurement of the electrical property, a frequency of oscillation of a structure (e.g., the sieve 102) vibrated by the oscillation control system in a system (e.g., a 3D printing system or another type of the system). The vibration of the structure causes passage of a portion of a material through the structure.

The tasks additionally include a material level estimating task 308 to estimate a level of a remaining portion of the material at the structure based on the determined frequency of oscillation of the structure.

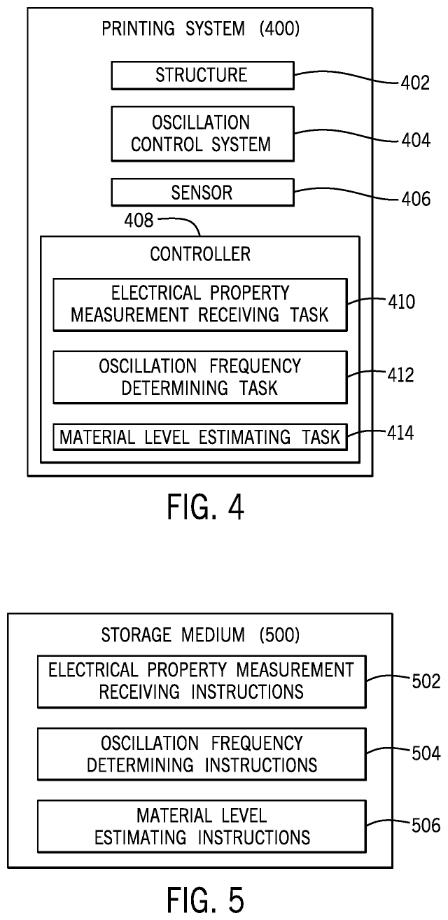

FIG. 4 is a block diagram of a printing system 400 that includes a structure 402 (e.g., the sieve 102) at which a material is collected. The printing system 400 further includes an oscillation control system 404 (e.g., including the vibrator mechanism 118, the controller 128, and the power control electronics 130 of FIG. 1) to vibrate the structure to cause passage of a portion of the material through the structure.

The printing system 400 further includes a sensor 406 coupled to the oscillation control system 404, and a controller 408 to perform various tasks. The tasks of the controller 408 include an electrical property measurement receiving task 410 to receive a measurement of an electrical property of the oscillation control system 404 from the sensor 406.

The tasks further include an oscillation frequency determining task 412 to determine, based on the measurement of the electrical property, a frequency of oscillation of the structure 402 vibrated by the oscillation control system 404.

The tasks further include a material level estimating task 414 to estimate a level of the material at the structure 402 based on the determined frequency of oscillation of the structure 402. The determined frequency of oscillation (e.g., resonant frequency) of the structure 402 can be affected by an amount of the material at the structure 402.

FIG. 5 is a block diagram of a non-transitory machine-readable or computer-readable storage medium 500 storing machine-readable instructions that upon execution cause a controller to perform various tasks. The machine-readable instructions include electrical property measurement receiving instructions 502 to receive a measurement of an electrical property of an oscillation control system from a sensor. The machine-readable instructions further include oscillation frequency determining instructions 504 to determine, based on the measurement of the electrical property, a frequency of oscillation of a structure vibrated by an oscillation control system, the vibration of the structure to cause passage of a portion of a material through the structure.

The machine-readable instructions further include material level estimating instructions 506 to, based on correlating different frequencies of oscillation of the structure to different masses each including the structure and a respective amount of the material at the structure, estimate a level of a remaining portion of the material at the structure according to the determined frequency of oscillation of the structure.

The storage medium 500 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus for a system, comprising:
a controller to:
receive a measurement of an electrical property of an oscillation control system from a sensor;
determine, based on the measurement of the electrical property, a frequency of oscillation of a structure vibrated by the oscillation control system in the system, the vibration of the structure to cause passage of a portion of a material through the structure; and
estimate a level of a remaining portion of the material at the structure based on the determined frequency of oscillation of the structure.

2. The apparatus of claim 1, further comprising the sensor, the sensor including an electrical current sensor to measure an electrical current of the oscillation control system.

3. The apparatus of claim 2, wherein the oscillation control system comprises an electromagnet actuator that is responsive to an input voltage to cause the vibration of the structure.

4. The apparatus of claim 3, wherein the controller is to determine an impedance based on the input voltage and the electrical current from the electrical current sensor, and determine the frequency of oscillation of the structure based on the impedance.

5. The apparatus of claim 1, wherein the determined frequency of oscillation of the structure is an estimated resonant frequency of oscillation of a mass that includes the structure and the remaining portion of the material at the structure, the resonant frequency of oscillation being based on the mass.

6. The apparatus of claim 5, further comprising:
a non-transitory storage medium to store correlation information relating different frequencies of oscillation to different levels of the material,
wherein the controller is to access the correlation information based on the determined frequency of oscillation of the structure to estimate the level of the remaining portion of the material at the structure.

7. The apparatus of claim 1, wherein the controller is to apply a formula or model relating different frequencies of oscillation to different levels of the material, the application of the formula or model comprising inputting the determined frequency of oscillation into the formula to produce an output, the controller to estimate the level of the remaining portion of the material at the structure based on the output.

8. The apparatus of claim 1, wherein the structure is a sieve to filter the material.

9. A printing system comprising:
a structure at which a material is collected;
an oscillation control system to vibrate the structure to cause passage of a portion of the material through the structure;
a sensor coupled to the oscillation control system; and
a controller to:
receive a measurement of an electrical property of the oscillation control system from the sensor;
determine, based on the measurement of the electrical property, a frequency of oscillation of the structure vibrated by the oscillation control system; and
estimate a level of the material at the structure based on the determined frequency of oscillation of the structure.

10. The printing system of claim 9, wherein the oscillation control system is operable by an oscillating input voltage.

11. The printing system of claim 10, wherein the electrical property comprises an electrical current, and wherein the controller is to:
compute an impedance based on the electrical current from the sensor and the oscillating input voltage, wherein the determined frequency of oscillation is based on the impedance.

12. The printing system of claim 9, wherein the structure comprises a sieve, and the printing system further comprises:
a container to receive the portion of the material passing through the sieve.

13. The printing system of claim 9, wherein the controller is to correlate different frequencies of oscillation to different levels of the material at the structure.

14. A non-transitory machine-readable storage medium storing instructions that upon execution cause a controller to:
receive a measurement of an electrical property of an oscillation control system from a sensor;
determine, based on the measurement of the electrical property, a frequency of oscillation of a structure vibrated by an oscillation control system, the vibration of the structure to cause passage of a portion of a material through the structure; and
based on correlating different frequencies of oscillation of the structure to different masses each including the structure and a respective amount of the material at the structure, estimate a level of a remaining portion of the material at the structure according to the determined frequency of oscillation of the structure.

15. The non-transitory machine-readable storage medium of claim 14, wherein the correlating uses stored correlation information, or a formula, or a model.
